(19) United States
(12) Patent Application Publication
(10) Pub. No.: US 2013/0316810 A1
(43) Pub. Date: Nov. 28, 2013

(54) GAME APPARATUS, NON-TRANSITORY COMPUTER READABLE RECORDING MEDIUM, AND GAME PROVIDING METHOD

(71) Applicants: Tatsuma Minami, Minato-ku (JP); Akitsu Terashima, Minato-ku (JP); Hiroto Yamaguchi, Minato-ku (JP)

(72) Inventors: Tatsuma Minami, Minato-ku (JP); Akitsu Terashima, Minato-ku (JP); Hiroto Yamaguchi, Minato-ku (JP)

(73) Assignee: KONAMI DIGITAL ENTERTAINMENT CO., LTD., Minato-ku, Tokyo (JP)

(21) Appl. No.: 13/983,111

(22) PCT Filed: May 16, 2012
(86) PCT No.: PCT/JP2012/062540

§ 371 Date: Aug. 1, 2013

(30) Foreign Application Priority Data
Sep. 29, 2011 (JP) 2011-214623

(51) Int. Cl. A63F 13/00

(52) U.S. Cl. CPC A63F 13/00
USPC 463/29

(57) ABSTRACT

A game apparatus assigns an item, which includes one or more characters and in which points are set for each character, to a player. A storage device stores items owned by the player. When an instruction is given to synthesize a first item and a second item out of multiple items stored in the storage device, a control device generates an item that includes a specific character common between the first and second items and in which points of the specific character are set according to points of the specific character of the first item and those of the specific character of the second item.

### TECHNICAL FIELD

The present invention relates to techniques for providing an item collection game.

### BACKGROUND ART

Games have been conventionally proposed in which items are assigned to a player by an execution of various events. For example, a game, in which an item represented by a card, on which a character such as a monster is drawn, is assigned to a player, is disclosed in non-patent literature 1.

### CITATION LIST

### Non-Patent Document

### Non-Patent Document 1

“Social Game General Information Magazine Appli-Style Vol. 2”, published by EastPress, Apr. 1, 2011, pp. 26-29.

### SUMMARY OF INVENTION

### Technical Problem

However, since one type of character is related to one item in the techniques of non-patent document 1, the number of the types of characters must be increased to diversify items, for example, in order to make a game more interesting. In view of the above situation, the present invention aims to diversify items without excessively increasing the types of characters.

### Solution to Problem

A game device according to a preferred aspect of the present invention is for assigning an item, which includes one or more characters and in which points are set for each character, to a player, and includes an item synthesizing unit for, when an instruction is given to synthesize a first item and a second item out of multiple items owned by the player, generating an item that includes a specific character in common between the first and second items and in which points of the specific character are set according to points of the specific character of the first item and those of the specific character of the second item.

It should be noted that the “generation of an item” at least includes a process for synthesizing the second item (material) based on the first item and a process for synthesizing a different item (however, the item includes the specific character) from the first and second items.

In a preferred aspect of the present invention, the item synthesizing unit generates the item in which points of the specific character common to the second item in the first item are updated according to points of the specific character of the first item and those of the specific character of the second item.

The game apparatus according to a preferred aspect of the present invention includes a point totaling unit for calculating a cumulative value of points of each character for two or more items owned by the player and a drawing processing unit for selecting an item to be assigned to the player from multiple items as drawing targets, and a probability that the item including a character whose cumulative value is greatest will be selected by the drawing processing unit is higher than other items.

In a preferred aspect of the present invention, the point totaling unit calculates the cumulative value of points of each character for a predetermined number of items selected by the player out of the multiple items owned by the player.

In a preferred aspect of the present invention, the drawing processing unit includes a first drawing unit for selecting any of multiple groups into which the multiple items as the drawing targets are divided, and a second drawing unit for selecting the item from the group selected by the first drawing unit such that the item including the character whose cumulative value is greatest is selected with a higher probability than the other items.

In a preferred example in which the drawing processing unit includes a first drawing unit and a second drawing unit, the second drawing unit repeats a drawing process for selecting the item from the group selected by the first drawing unit with a predetermined number of times set as an upper limit until the item including the character whose cumulative value is greatest is selected. Furthermore, in another aspect, the second drawing unit repeats the drawing process for selecting an item from the group selected by the first drawing unit a predetermined number of times and, when multiple items including the character whose cumulative value is greatest are selected by the predetermined number of drawing processes, selects any of the multiple items (e.g., an item corresponding to an instruction from the player or item determined by the drawing). The second drawing unit can also variably set the upper limit of a repetition count of the drawing process according to the cumulative value.

The present invention is also specified as a program for causing a computer to function as the game apparatus according to each of the above aspects. To provide a game in which an item, which includes one or more characters and in which points are set for each character, is assigned to a player, the program of the present invention causes the computer to function as an item synthesizing unit for, when an instruction is given to synthesize a first item and a second item out of multiple items owned by the player, updating points of a specific character common to the second item in the first item according to points of the specific character of the first item and those of the specific character of the second item. The program of the present invention is installed in the computer by being provided in the form of delivery via a communication network besides being provided in a form stored in a computer-readable storage medium.

The present invention is also specified as a method for providing a game. A game providing method of the present invention is a method for providing a game in which an item, which includes one or more characters and in which points are set for each character, is assigned to a player. When an instruction is given to synthesize a first item and a second item out of multiple items owned by the player, an item is generated which includes a specific character common between the first and second items and in which points of the specific character are set according to points of the specific character of the first item and those of the specific character of the second item.

### BRIEF DESCRIPTION OF DRAWINGS

FIG. 1 is a block diagram of a game system according to a first embodiment of the present invention,

FIG. 2 is a schematic diagram of base item data,

FIG. 3 is a schematic diagram of player data,

FIG. 4 is an explanatory diagram outlining the operation of a game apparatus,

FIG. 5 is a flow chart of an item synthesis event,

FIG. 6A is an explanatory diagram of the player data before item synthesis,

FIG. 6B is an explanatory diagram of the player data after item synthesis,

FIG. 7 is a flow chart of a second drawing,

FIG. 8 is a block diagram of a game apparatus in a second embodiment,

FIG. 9A is an explanatory diagram of player data before item synthesis in a modification,

FIG. 9B is an explanatory diagram of player data after item synthesis in the modification, and

FIG. 10 is an explanatory diagram of a process corresponding to a cumulative value of a priority character.

### EMBODIMENTS OF INVENTION

### First Embodiment

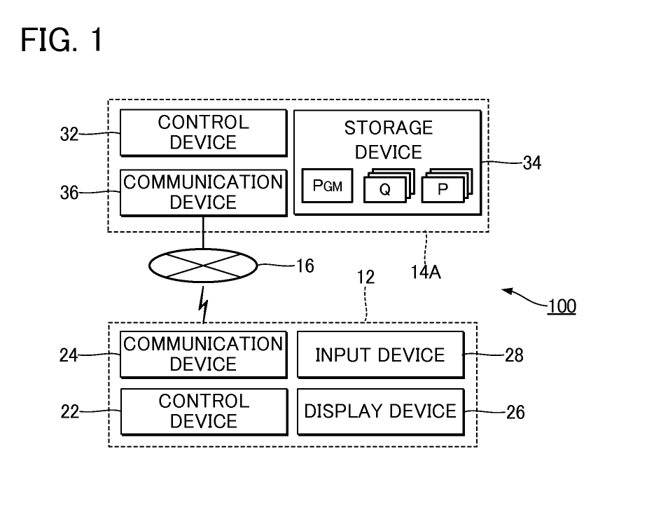

FIG. 1 is a block diagram of a game system 100 according to a first embodiment of the present invention. The game system 100 of the first embodiment includes a terminal device 12 and a game apparatus 14A that communicate with each other via a communication network 16 (e.g., the Internet). The game apparatus 14A provides a game to a player who owns the terminal device 12. It should be noted that although only one terminal device 12 is shown for convenience in FIG. 1, multiple terminal devices 12 actually communicate with the game apparatus 14A via the communication network 16.

Each terminal device 12 is, for example, a communication terminal such as a mobile phone or a personal digital assistant (PDA) and includes a control device 22, a communication device 24, a display device 26 and an input device 28. The control device 22 centrally controls each element of the terminal device 12. The communication device 24 communicates with the game apparatus 14A via the communication network 16. It should be noted that although communication between the terminal device 12 and the communication network 16 is typically wireless communication, the terminal device 12 and the communication network 16 may use wired communication, for example, in a configuration in which a stationary personal computer or the like is used as the terminal device 12.

The display device 26 (e.g. liquid crystal display panel) displays various images under the control of the control device 22. For example, images (hereinafter, referred to as “game screens”) of a game provided from the game apparatus 14A are displayed on the display device 26. The input device 28 is a device used by a player to input an instruction to the terminal device 12 and, for example, includes multiple manipulanda to be operated by the player. It should be noted that it is also possible to use a touch panel integrally formed with the display device 26 and a microphone used to input an instruction to the terminal device 12 by speech as the input device 28.

The game apparatus 14A of the first embodiment is a web server for providing a browser game, in which items are acquired and collected by an execution of various events, to a player, and realized by a computer system including a control device 32, a storage device 34 and a communication device 36. The control device 32 centrally controls each element of the game apparatus 14A by executing a program PGM stored in the storage device 34. The communication device 36 communicates with each terminal device 12 via the communication network 16. The storage device 34 stores the program PGM to be executed by the control device 32 and various data used by the control device 32. A known storage medium or a combination of multiple types of recording media such as semiconductor recording media and magnetic recording media can be adopted as the storage device 34. It should be noted that it is also possible to adopt a configuration in which the storage device 34 is installed in an external device (e.g., server device) different from the game apparatus 14A and the game apparatus 14A obtains information from the storage device 34 via the communication network 16. Specifically, the storage device 34 is not an essential element of the game apparatus 14A. Furthermore, it is also possible to configure the storage device 34 (virtual one storage device), for example, by multiple server devices installed at geographically different locations.

The storage device 34 stores multiple items that become candidates to be assigned to players. Specifically, multiple base item data (master data) Q corresponding to mutually different items are stored in the storage device 34. In the first embodiment, one or more types of characters correspond to one item. Specifically, one or more members selected by a freely selected combination from a group corresponds to an item targeted for the group composed of multiple members such as singers and actors.

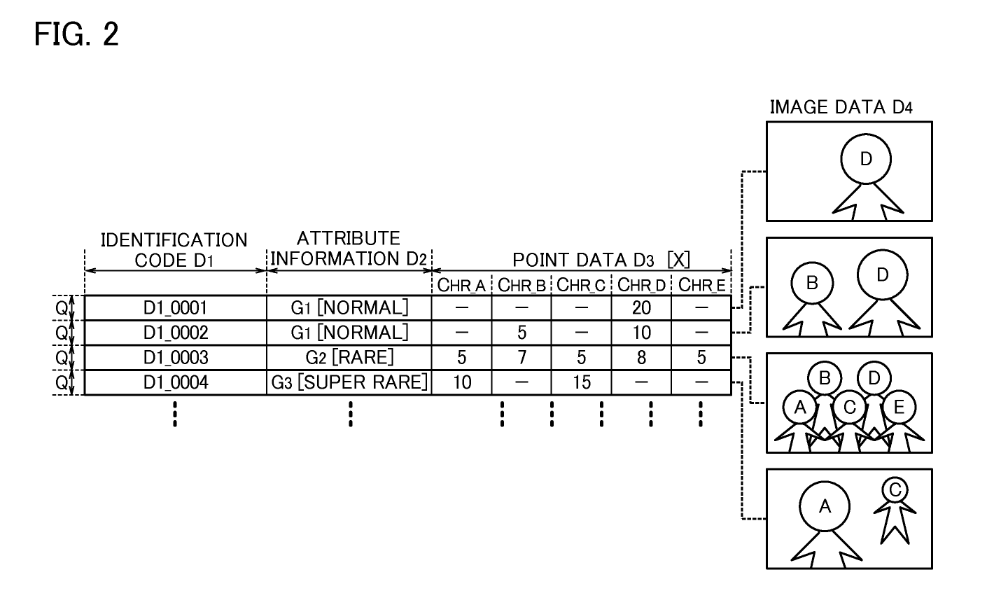

FIG. 2 is a schematic diagram of the multiple base item data Q stored in the storage device 34. As shown in FIG. 2, each base item data Q is configured to include an identification code D1, an attribute information D2, point data D3 and image data D4. It should be noted that although the base item data Q is illustrated to be stored in the single storage device 34 in the first embodiment, the respective data can also be retained while being scattered in multiple storage devices. For example, the image data D4 of each item can be stored in a storage device different from the one for the other data D1 to D3. The identification code D1 is uniquely assigned to each item and used to identify each item.

Multiple items stored in the storage device 34 are divided into multiple groups G (G1 to G3) having different probabilities (frequencies) of being assigned to players. Multiple items belong to each group G. The group G2 is a set of items (rare items) having a lower probability of being assigned to players as compared with the group G1, and the group G3 is a set of items (super rare items) having a lower probability of being assigned to players as compared with the group G2. As shown in FIG. 2, the attribute information D2 of the base item data Q designates the group G (any of G1 to G3) to which the item belongs.

The point data D3 of each base item data Q designates an initial value of points X of each character included in the item. As shown in FIG. 2, in the base item data Q of an item with an identification code D1_0001 including only a character CHR_D, the points X of the character CHR_D are designated. In the base item data Q of an item with an identification code D1_0002 including characters CHR_B and CHR_D, the points X of each of the characters CHR_B and CHR_D are designated. The points X are a numerical value (score) that can be changed for each character along with the progress of a game such as an execution of events. It is one purpose of the game to increase the points X of the favorite character of the player.

The image data D4 of each item indicates an image of that item. Specifically, the image data D4 of each item indicates an image in which one or more types of characters corresponding to that item are drawn. Specifically, an image of a commercial portrait of celebrities in which one or more members corresponding to the item are drawn as characters is represented by the image data D4. For example, the item with the identification code D1_0001 illustrated in FIG. 2 is represented by an image including only the character CHR_D, and an item with an identification code D1_0002 is represented by an image including the characters CHR_B and CHR_D. An item with an identification code D1_0003 is represented by an image including five types of characters (CHR_A to CHR_E). As is understood from the above description, even if the characters of the respective items partly overlap, these items are distinguished as different items if combinations of the characters differ.

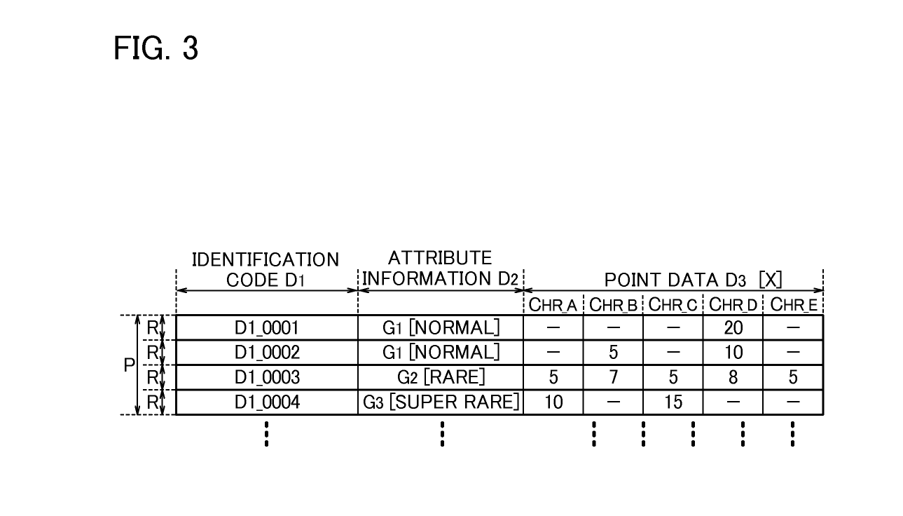

Furthermore, the storage device 34 of FIG. 1 stores the player data P for each player. FIG. 3 is a schematic diagram of the player data P of one player. As shown in FIG. 3, the player data P of each player is configured to include multiple owned item data R corresponding to the respective items owned by that player. The owned item data R of each item is configured to include the identification code D1, the attribute information D2 and the point data D3 of that item. Out of the multiple base item data Q stored in the storage device 34, the identification code D1, the attribute information D2 and the point data D3 of the base item data Q corresponding to the item assigned to the player are included in the player data P as initial owned item data R. A case in which the player owns four items with the identification codes D1_0001 to D1_0004 is illustrated in FIG. 3.

It should be noted that although the owned item data R are illustrated to be included in the player data P of each player in the first embodiment, it is also possible to store a table (hereinafter, referred to as an “item table”), in which the own item data R of all the players are collectively arranged, in the storage device 34. The item table relates the owned item data R of each item assigned to the player to the identification code of the player owning that item. By extracting the owned item data R corresponding to the identification code of a specific player from the item table, the items owned by that player are specified. By extracting the owned item data R of a specific item from the item table, an assignment number (total number circulated in the game) of that item is specified. As is understood from the above description, the storage device 34 functions as an element (storage unit) for storing the items owned by the players.

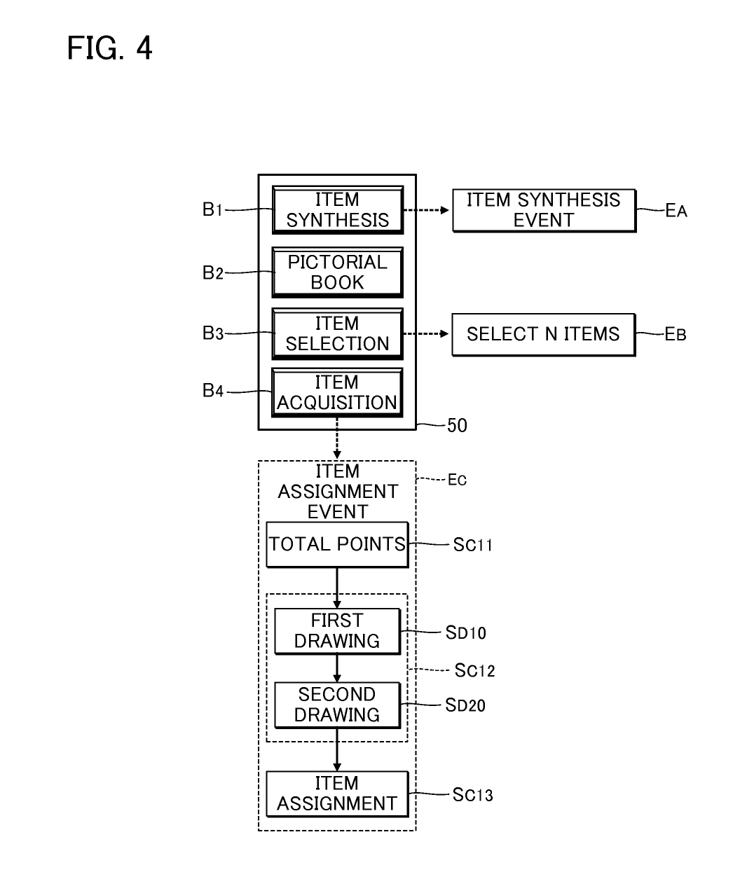

The control device 32 of FIG. 1 performs a predetermined process corresponding to a request transmitted from the terminal device 12, triggered by an operation performed on the input device 28, and transmits image data of a game screen (web page) indicating a result of the process from the communication device 36 to the terminal device 12, thereby causing the display device 26 to display the game screen. For example, if the player gives an instruction to start the game to the input device 28, the control device 32 causes the display device 26 of the terminal device 12 to display a game screen 50 of FIG. 4. Multiple buttons B (B1 to B4) are arranged on the game screen 50. Each button B is an image of a manipulandum (link object such as a command button) selectively operable by the player. The control device 32 performs a process corresponding to the button B operated by the player out of the multiple buttons B1 to B4.

If the player operates the button B1 (item synthesis), the control device 32 performs an item synthesis event EA of synthesizing multiple items (i.e., items owned by the player) designated by the player data P stored in the storage device 34.

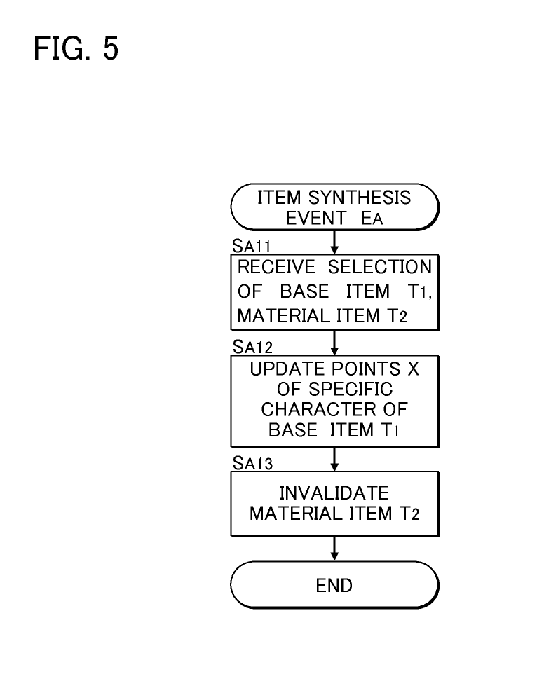

FIG. 5 is a flow chart showing specific contents of the item synthesis event EA. The player having operated the button B1 freely selects an item as a base of synthesis (hereinafter, referred to as a “base item”) T1 and an item as a material of synthesis (hereinafter, referred to as a “material item”) T2 from multiple items owned by the player by appropriately operating the input device 28 of the terminal device 12. The control device 32 receives the selection of the base item T1 and the material item T2 via the communication network 16 from the terminal device 12 (SA11). It should be noted that, in addition to the items in an initial state assigned to the player, items after the synthesis by the past item synthesis events EA can also be selected as the base item T1 or the material item T2.

When receiving the selection of the base item T1 and the material item T2 (synthesis instruction), the control device 32 updates points X of a character common to the material item T2 in the base item T1 (hereinafter, referred to as a “specific character”) to a numerical value corresponding to points X1 indicated by the owned item data R of the base item T1 for the specific character and points X2 indicated by the owned item data R of the material item T2 for the specific character (SA12). For example, the control device 32 calculates a weighted sum of the points X1 of the specific character in the base item T1 and the points X2 of the specific character in the material item T2 as the points X after the updating as expressed by the following equation (1).

X=α1·X1+α2·X2 (1)

Weighted values α1, α2 of the equation (1) are set at specified positive numbers. A case in which the weighted value α1 is set at 1 and the weighted value α2 is set at 0.4 is illustrated in the following description.

It should be noted that although the weighted values α1, α2 are set at fixed values in the above example, it is also possible to variably control the weighted values α1, α2 by an free method. Specifically, a configuration is adopted in which one or both of the weighted values α1, α2 are variably set according to the group G designated by the attribute information D2 of each item. For example, if the material item T2 is an item of the group G2 (rare item), the weighted value α2 is set at a larger numerical value (e.g., 0.4) as compared with the case in which the material item T2 is an item of the group G1 (normal item). If the material item T2 is an item of the group G3 (super rare item), the weighted value α2 is set at a greater numerical value (e.g., 2) as compared with the case in which the material item T2 is an item of the group G2. Furthermore, it is also possible to individually set one or both of the weighted values α1, α2 for each item. For example, the weighted value α2 of the item of the group G1 is set for each item within the range of 0.4 or greater and 0.8 or less, and the weighted value α2 of the item of the group G2 is set for each item within the range of 0.8 or greater and 1.6 or less. The weighted value α2 of the item of the group G2 is set for each item within the range of 1.6 or greater and 2 or less. It should be noted that although the weighted value α2 is referred to in the above example, it is also possible to variably set the weighted value al according to the base item T1 as in the above example.

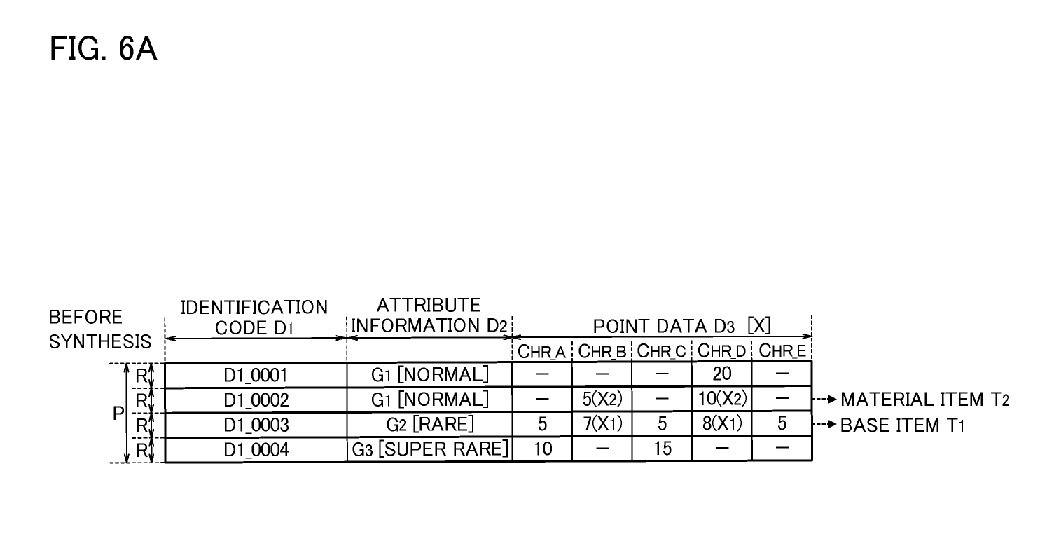

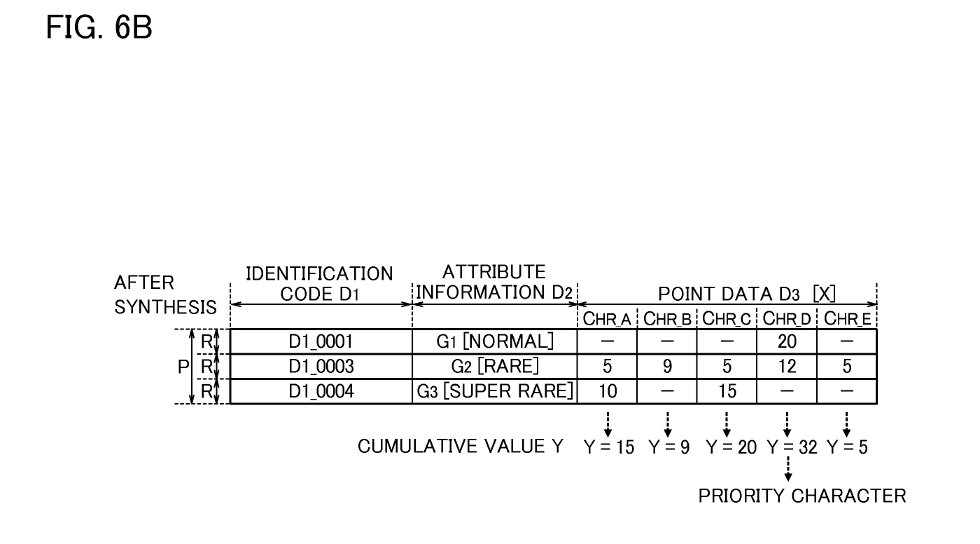

Assuming that the player owning four items with the identification codes D1_0001 to D1_0004 selects the item with the identification code D1_0003 as the base item T1 and the item with the identification code D1_0002 as the material item T2 as shown in FIG. 6A. The base item T1 includes five types of characters CHR_A to CHR_E, and the material item T2 includes two types of characters CHR_B and CHR_D. Thus, the characters CHR_B and CHR_D fall under the specific characters.

FIG. 6B is a schematic diagram of the player data P after the synthesis of the base item T1 and the material item T2 (SA12). As shown by hatching in FIG. 6B, the points X of the specific characters (CHR_B, CHR_D) out of the owned item data R of the base item T1 are updated. Specifically, the points X of the specific character CHR_B in the base item T1 are updated to a numerical value “9” (X=1×7+0.4×5) obtained by applying the points X1 (X1=7) of the specific character CHR_B before the synthesis in the base item T1 and the points X2 (X2=5) of the specific character CHR_B before the synthesis in the material item T2 to the equation (1). Furthermore, the points X of the specific character CHR_D in the base item T1 are updated to a numerical value “12” (X=1×8+0.4×10) obtained by applying the points X1 (X1=8) of the specific character CHR_D before the synthesis in the base item T1 and the points X2 (X2=10) of the specific character CHR_D before the synthesis in the material item T2 to the equation (1). On the other hand, out of the owned item data R of the base item T1, the points X of the characters (CHR_A, CHR_C, CHR_E) other than the specific characters are not changed before and after the synthesis. The identification codes D1 and the attribute information D2 of the owned item data R are maintained to be the contents in the base item T1 before the synthesis.

When the points X of the base item T1 are updated in the above procedure, the control device 32 invalidates the material item T2 (SA13). For example, the control device 32 deletes the owned item data R of the material item T2 from the player data P as shown in FIG. 6B. As is understood from the above description, the item synthesis event EA is an event of increasing the points X of the specific character of the base item T1 in exchange for the consumption (invalidation) of the material item T2. By selecting the items including the player's favorite character as the base item T1 and the material item T2, the player is able to increase the points X of that character.

When the player operates the button B2 (pictorial book) of the game screen 50 of FIG. 4, the control device 32 causes the display device 26 to display a list of images of the respective items (pictorial book) by transmitting the image data D4 of the items owned by the player to the terminal device 12. It should be noted that when the button B2 is operated, items acquired in the past, but not presently owned by the player (e.g., items invalidated by execution of various events after the acquisition) are also displayed on the display device 26 in addition to the items acquired in the past and presently owned by the player (items designated by the owned item data R of the player data P).

When the player operates the button B3 (item selection) of the game screen 50 of FIG. 4, the control device 32 lets the player select N (N is a natural number not less than 2) items (hereinafter, referred to as “designated items”) out of multiple items designated by the player data P stored in the storage device 34 (EB). Specifically, the player selects N designated items including a desired character (e.g., a player's favorite character) by appropriately operating the input device 28 and the control device 32 receives the selection of the N designated items by the player.

When the player operates the button B4 (item acquisition) of the game screen 50 of FIG. 4, the control device 32 executes an item assignment event EC for assigning an item to the player. It should be noted that the number of the executions of the item assignment event EC per unit time is restricted to a predetermined number (e.g., once a day). However, the item assignment event EC can be executed without any restriction on the number of times, for example, by consuming virtual money in the game.

When the item assignment event EC is started, the control device 32 calculates a cumulative value Y of the points X of each character for the N designated items selected in the above Step EB (SC11). The cumulative value Y of each character is a numerical value obtained by totaling the points X designated for that character by each owned item data R of the player data P for the N designated items as shown in FIG. 6B. In FIG. 6B, assuming that the player selects three items with the identification codes D1_0001, D1_0003 and D1_0004 as the designated items. The player is able to increase the points X of a desired character by the item synthesis event EA and select designated items including the player's favorite character. Thus, the cumulative value Y of the player's favorite character tends to be large. As is understood from the above description, the control device 32 performs Step SC11 to realize an element for calculating the cumulative value Y of the points X of each character (point totaling unit).

As shown in FIG. 4, the control device 32 performs a drawing process SC12 for selecting an item according to the cumulative value Y of each character from multiple items (drawing targets) whose base item data Q are stored in the storage device 34. Then, the control device 32 assigns the item selected in the drawing process SC12 to the player (SC13). Specifically, out of the base item data Q of the item selected in the drawing process SC12, the identification code D1, the attribute information D2 and the point data D3 are added as initial owned item data R to the player data P. As is understood from the above description, the control device 32 performs Step SC12 to realize an element for selecting an item to be assigned to the player out of multiple items (drawing processing unit).

As shown in FIG. 4, the drawing process SC12 is configured to include a first drawing SD10 for selecting any of the multiple groups G (G1 to G3) and a second drawing SD20 for selecting an item to be assigned to the player from one group G selected in the first drawing SD10. In the first drawing SD10, the control device 32 generates a random number, for example, within a predetermined range, and selects the group G corresponding to that random number. However, a probability of selecting the group G2 in the first drawing SD10 is below that of selecting the group G1, and a probability of selecting the group G3 in the first drawing SD10 is below that of selecting the group G2.

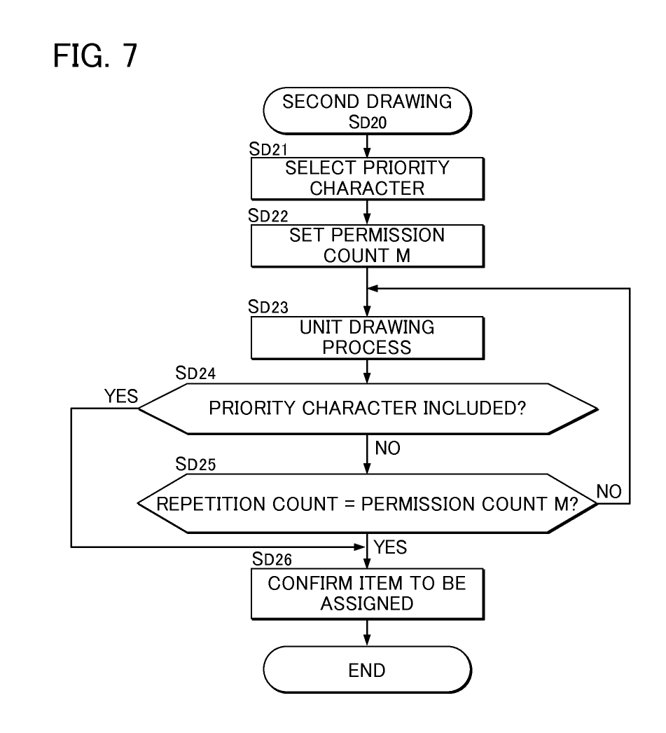

FIG. 7 is a flow chart of a specific process of the second drawing SD20. When the second drawing SD20 is started, the control device 32 specifies a character (hereinafter, referred to as a “priority character”) having a greatest cumulative value Y calculated in Step SC11 out of multiple characters included in each item designated by the player data P (items owned by the player) (SD21). The control device 32 selects one item from the group G selected in the first drawing SD10 such that the item including the priority character is selected with a higher probability than other items (items not including the priority character) (SD22 to SD26). Specifically, the control device 32 repeats a unit drawing process SD23 for selecting one item from the group G selected in the first drawing SD10 with a permission count M set as an upper limit until the item including the priority character is selected as described in detail below.

First, the control device 32 variably sets the permission count M (SD22). Specifically, the permission count M is controlled according to the cumulative value Y of the priority character. For example, the control device 32 sets the repetition count M to a larger numerical value as the cumulative value Y of the priority character increases.

The control device 32 performs the unit drawing process for selecting one item from the group G selected in the first drawing SD10 (SD23). Specifically, the control device 32 generates a random number within a predetermined range and selects one item corresponding to that random number. Then, the control device 32 determines whether or not the item selected in the unit drawing process includes the priority character (SD24). For example, the presence or absence of the priority character is determined based on whether or not the base item data Q of the item selected in the unit drawing process designates a significant numerical value as the points X of the priority character.

If a determination result of Step SD24 is affirmative, the control device 32 determines the item selected in the last unit drawing process (i.e., item including the priority character) as an item to be assigned to the player (SD26). On the other hand, if the item selected in the unit drawing process does not include the priority character (SD24: NO), the control device 32 determines whether or not a repetition count of the unit drawing process has reached the permission count M set in Step SD22 (SD25). If a determination result of Step SD25 is negative, the control device 32 proceeds to Step SD23 and repeats the unit drawing process.

On the other hand, if the repetition count of the unit drawing process reaches the permission count M (SD25: YES) without the item including the priority character being selected, the control device 32 determines the item selected in the last unit drawing process (i.e., the item not including the priority character) as an item to be assigned to the player (SD26). As is understood from the above description, since the unit drawing process is repeated with the permission count M set as an upper limit until the priority character is selected, the item including the priority character is selected with a higher probability than the other items in the second drawing SD20. As is understood from the above description, the control device 32 performs the first drawing SD10 to realize an element for selecting any of the multiple groups G (first drawing unit), and the control device 32 performs the second drawing SD20 to realize an element for selecting an item from the group G selected in the first drawing SD10 (second drawing unit).

As described above, in the first embodiment, items having different combinations of characters are distinguished as different items since one or more characters correspond to each item. Accordingly, items can be diversified without excessively increasing the number of types of characters as compared with the technology of non-patent document 1 for relating only one type of character to one item. In addition, the points X of the specific character common between the base item T1 and the material item T2 are updated to the numerical value corresponding to the points X1 of the specific character in the base item T1 and the points X2 of the specific character in the material item T2. Thus, the points X of a desired character of the player can be selectively changed by the item synthesis event EA regardless of the configuration in which one item includes multiple characters. Particularly in the first embodiment, since the points X of the specific character out of multiple characters of the base item T1 are updated according to the points X of the specific character in each of the base item T1 and the material item T2, a combination of the characters in the base item T1 is maintained also after the synthesis. Therefore, it is, for example, possible to change the points X of a desired character while maintaining the respective characters of the base item T1.

Furthermore, in the first embodiment, the cumulative value Y of the points X of each character is calculated for the N designated items owned by the player and the item including the priority character having the greatest cumulative value Y is selected with a higher probability than the items not including the character in the drawing process SC12 (second drawing SD20). Specifically, the item including the priority character whose points X were increased by the player in the item synthesis event EA (typically a player's favorite character) is likely to be assigned to the player in the item assignment event EC. Thus, there is an advantage of being able to give an incentive to execute the item synthesis event EA to the player aiming to acquire the item including the player's favorite character. Particularly in the first embodiment, since the N designated items, for which the cumulative value Y of each character is to be calculated, are selected by the player, an effect that the item including the character desired by the player is likely to be selected in the drawing process SC12 is especially notable.

In the first embodiment, the item including the priority character is selected with a higher probability than the other items in the second drawing SD20 by repeating the unit drawing process with the permission count M set as an upper limit until the priority character is selected. Since an item selection probability is controlled by the repetition of the unit drawing process as described above, a special control to increase the selection probability of the item including the priority character is not necessary. Specifically, according to the first embodiment, there is an advantage of being able to very easily control the selection probability of the item including the priority character.

In the first embodiment, the group G is selected in the first drawing SD10 and the item in the group G selected in the first drawing SD10 is selected in the second drawing SD20. Accordingly, a probability of selecting each item can be made different for each group G by a simple configuration. Furthermore, since the permission count M of the unit drawing process is variably set according to the cumulative value Y of the priority character, an incentive to increase the points X of the player's favorite character out of multiple characters can be given to the player.

### Second Embodiment

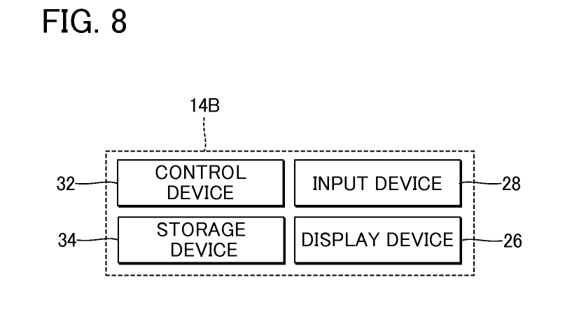

FIG. 8 is a block diagram of a game apparatus 14B of a second embodiment. The game apparatus 14B is an electronic device that allows a player (owner) to play a game similar to that of the first embodiment. For example, a mobile device such as a mobile phone or a personal digital assistant is suitable as the game apparatus 14B. As shown in FIG. 8, the game apparatus 14B includes a control device 32, a storage device 34, a display device 26 and an input device 28.

Similarly to the first embodiment, the storage device 34 stores a program PGM, player data P and multiple base item data Q. The control device 32 operates as in the first embodiment by executing the program PGM. Specifically, the control device 32 selectively executes an item synthesis event EA and an item assignment event EC in response to an instruction (operation of a button B displayed on the display device 26) from the player.

As is understood from the above description, the game apparatus 14A of the second embodiment functions as a device that singly provides a game provided by the game apparatus 14A of the first embodiment to a player. Thus, effects similar to those of the first embodiment are realized also in the second embodiment.

### Variations

Each embodiment described above can be modified in various ways. Specific modes of modification are illustrated below. Two or more modes freely selected from the following examples can be appropriately combined without conflicting with each other.

(1) Although the points X of the specific character out of the base item T1 are changed according to the material item T2 in the item synthesis event EA of each embodiment described above, an item different from the item as the material of the synthesis can also be generated in the item synthesis event EA.

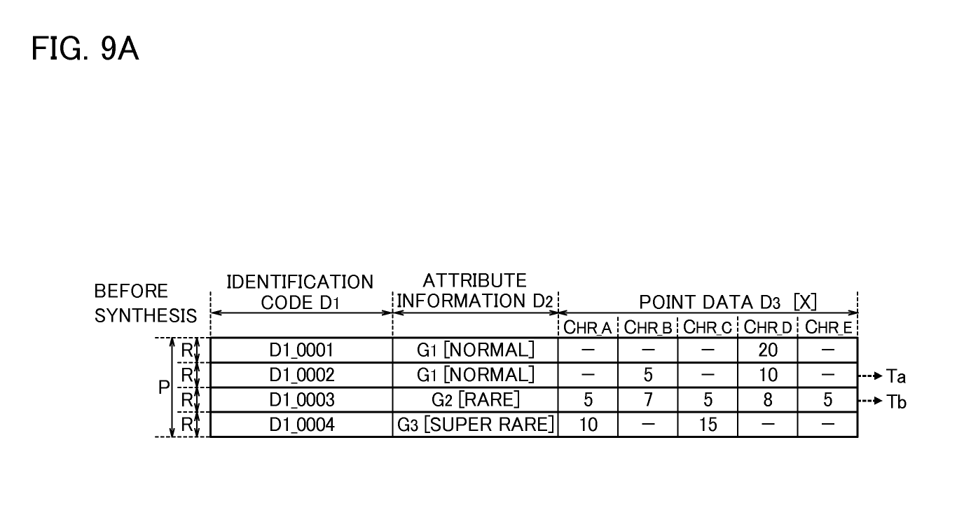

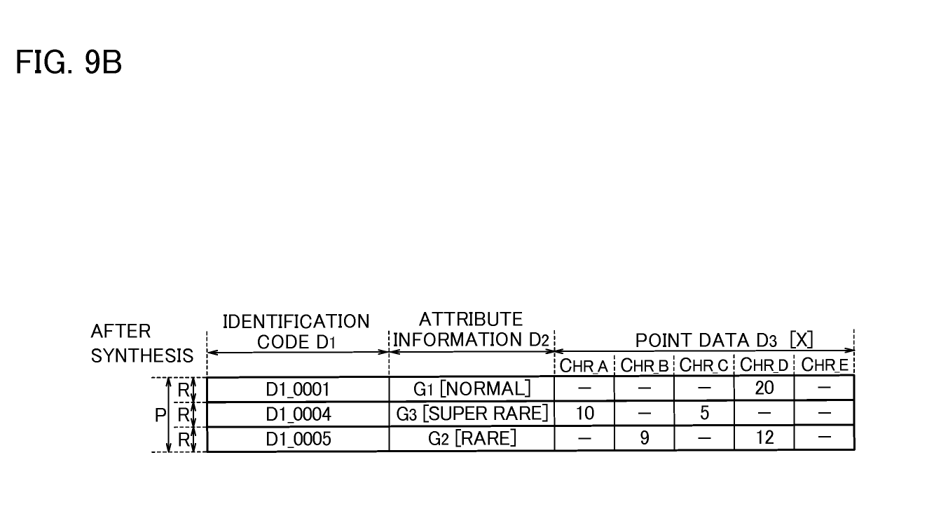

For example, assume that a player owns an item (first item) Ta with an identification code D1_0002 including characters CHR_B and CHR_D and an item (second item) Tb with an identification code D1_0003 including characters CHR_A to CHR_E as shown in FIG. 9A. If it is instructed to synthesize the items Ta and Tb, the control device 32 generates owned item data R (identification code D1_0005) of an item including specific characters CHR_B and CHR_D common between the two items, adds the generated data to the player data P and invalidates the items Ta and Tb used as materials of the synthesis (e.g., deletes the owned item data R from the player data P) as shown in FIG. 9B. The owned item data R after the synthesis includes the identification code D1 (D1_0005) and attribute information D2 of the base item data Q including the specific characters CHR_B and CHR_D out of the base item data Q stored in the storage device 34. Furthermore, the points X of the character CHR_B out of the owned item data R after the synthesis are set at a numerical value (e.g., a weighted sum defined by the equation (1) described above) corresponding to the points X of the character CHR_B in each of the items Ta and Tb before the synthesis. The same holds for the points of the character CHR_D. Specifically, superior and subordinate items (base item T1/material item T2) are not distinguished among multiple items used for the synthesis.

As is understood from the above description, the item synthesis event EA is comprehended as a process for generating an item which includes a specific character common between multiple items (first item, second item) as materials of synthesis and in which points of the specific character are set according to points of the specific character of the first item and those of the specific character of the second item and includes both a process for generating the same type of item before the synthesis (e.g., first embodiment for generating an item that is of the same type as the base item T1 and in which the points X of the specific character are updated) and a process for generating an item of a type different from the item before the synthesis (e.g., a configuration illustrated in FIGS. 9A and 9B). Specifically, it does not matter in the present invention whether the type of the item is the same or different before and after the synthesis. In other words, the control device 32 executes the item synthesis event EA to realize an element (item synthesizing unit) for generating an item set according to the points of the specific character of the first item and those of the specific character of the second item.

(2) It is also possible to add award data to items after the synthesis if multiple items are synthesized. For example, it is preferable to add award data when the maximum value of the points X of the item after the synthesis exceeds a predetermined value. The award data is, for example, voice data indicating the voice of a character included in the item after the synthesis and text data indicating lines of that character. When the player selects an item displayed in a list format by operating the button B2 (pictorial book) of FIG. 4, award data added to that item is output. For example, voices of the voice data are reproduced and characters of the text data are displayed on the display device 26 together with an image of the item. Furthermore, a configuration is also adopted in which an image mode of an item is changed with a combination of characters maintained in the case of synthesizing multiple items (e.g., if the maximum value of the points X exceeds the predetermined value). According to the above configuration, there is an advantage of being able to give an incentive to execute the item synthesis event EA to the player.

(3) Although the item including the priority character whose cumulative value Y is greatest is selected with high probability in the item assignment event EC of each embodiment described above, a method for reflecting the cumulative value Y on the selection of the item (drawing process SC12) is not limited to the above example. Specifically, it is also possible to change the type of an item to be assigned to the player according to the numerical value of the cumulative value Y of the priority character as illustrated below.

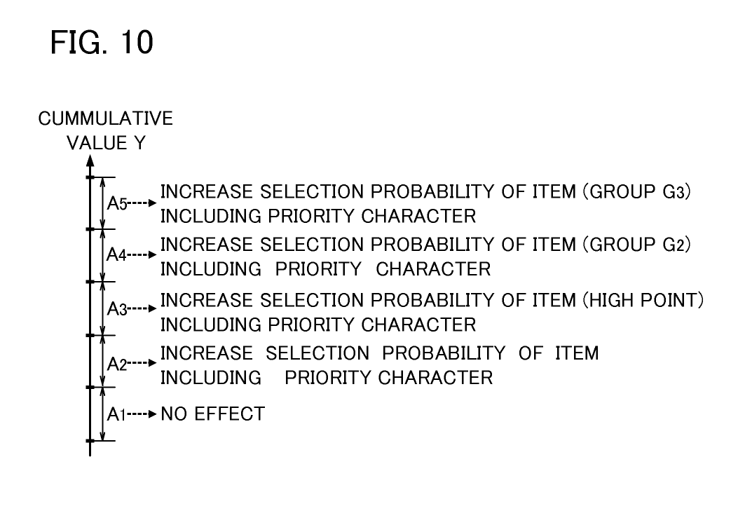

As shown in FIG. 10, a numerical value range of the cumulative value Y is divided into multiple ranges A1 to A5. The numerical values in the respective ranges increase from the range A1 toward the range A5. The control device 32 selects a freely selected item including the priority character with a high probability as in the first embodiment when the cumulative value Y of the priority character is a numerical value in the range A2, and selects an item, in which the points X of the priority character exceed a predetermined value with a high probability, out of multiple items, when the cumulative value Y of the priority character is a numerical value in the range A3. Furthermore, the control device 32 selects an item belonging to the group G2 (rare item including the priority character) out of the multiple items including the priority character with a high probability when the cumulative value Y of the priority character is a numerical value in the range A4, and selects an item belonging to the group G3 out of the multiple items including the priority character with a high probability when the cumulative value Y of the priority character is a numerical value in the range A5. On the other hand, the control device 32 selects the items including the priority character and the other items with the same probability when the cumulative value Y of the priority character is a numerical value in the range A1. Specifically, the permission count M is set to 0 (the unit drawing process is not repeated). According to the above configuration, there is an advantage of being able to give an incentive to execute the item synthesis event EA to the player with the aim of increasing the points X of the player's favorite character.

(4) It is also possible to variably control the permission count M according to the cumulative value Y of the priority character. For example, a configuration for setting the permission count M to 0 (the unit drawing process is not repeated) when the cumulative value Y of the priority character is below a predetermined threshold value and a configuration for lifting the restriction of the permission count M (the unit drawing process is repeated until the item including the priority character is selected) when the cumulative value Y of the priority character exceeds a predetermined threshold value) are also adopted. Furthermore, it is also possible to divide the numerical value range of the cumulative value Y into multiple ranges A (A1 to A5), for example, as illustrated in FIG. 10, and make the permission count M different according to the range A of the cumulative value Y.

(5) Although the unit drawing process is repeated with the permission count M set as an upper limit until the priority character is selected in each embodiment described above, the configuration for selecting the item including the priority character is not limited to the above example. For example, it is also possible to repeat the unit drawing process until the permission count M is reached regardless of whether or not the priority character is selected and select any item out of multiple items (e.g. items designated by the player or items determined by a drawing) if multiple items including the priority character are selected by the permission count M of unit drawing processes.

(6) Although the player selects the N designated items in each embodiment described above, a method for selecting designated items may be freely selected. For example, it is also possible to adopt a configuration for randomly selecting N designated items from items owned by the player or a configuration for selecting N items ranking high in the points X of the specific character as designated items. Furthermore, the total number of designated items may be freely selected. For example, a configuration for selecting one designated item may also be adopted.

(7) Although the owned item data R of the material item T2 (items Ta and Tb in the example of FIGS. 9A and 9B) are deleted from the player data P in the item synthesis event EA of each embodiment described above, a method for invalidating the items applied for the item synthesis event EA is appropriately changed. For example, a configuration is also adopted in which flags indicating whether the item owned by the player is valid or invalid are set for each owned item data R in the player data P and the flag of the item applied for the item synthesis event EA (e.g., the material item T2 in the first embodiment or the items Ta and Tb in the example of FIGS. 9A and 9B) is changed from a valid state to an invalid state (the owned item data R itself is maintained in the player data P).

Although the items targeted for groups including multiple members such as singers and actors are assumed and one member of the group is related to one type of character of each item in each embodiment described above, it is also possible to relate multiple members of the group to a character of each item. For example, four out of seven members constituting a group are related one-to-one to the characters CHR_A to CHR_D and the remaining three members are related to the character CHR_E. An image indicated by image data D4 of the item including the character CHR_E includes an image of one or more of the multiple members related to the character CHR_E.

### LIST OF REFERENCE SIGNS

100 . . . game system, 12 . . . terminal device, 14A, 14B . . . game apparatus, 16 . . . communication network, 22 . . . control device, 24 . . . communication device, 26 . . . display device, 28 . . . input device, 32 . . . control device, 34 . . . storage device, 36 . . . communication device

1. A game apparatus for assigning an item, which includes one or more characters and in which points are set for each character, to a player, comprising:
an item synthesizing unit adapted for, when an instruction is given to synthesize a first item and a second item out of multiple items owned by the player, generating an item that includes a specific character common between the first and second items and in which points of the specific character are set according to points of the specific character of the first item and those of the specific character of the second item.

2. The game apparatus according to claim 1, wherein the item synthesizing unit generates the item in which points of the specific character common to the second item in the first item are updated according to points of the specific character of the first item and those of the specific character of the second item.

3. The game apparatus according to claim 1, comprising:
a point totaling unit for calculating a cumulative value of points of each character for two or more items owned by the player; and
a drawing processing unit for selecting an item to be assigned to the player from multiple items as drawing targets;
wherein a probability that the item including a character whose cumulative value is greatest will be selected by the drawing processing unit is higher than for other items.

4. The game apparatus according to claim 3, wherein the point totaling unit calculates the cumulative value of points of each character for a predetermined number of items selected by the player out of the multiple items owned by the player.

5. The game apparatus according to claim 3, wherein the drawing processing unit comprises:
a first drawing unit adapted for selecting any of multiple groups into which the multiple items as the drawing targets are divided; and
a second drawing unit adapted for selecting the item from the group selected by the first drawing unit such that the item including the character whose cumulative value is greatest will be selected with a higher probability than other items.

6. The game apparatus according to claim 5, wherein the second drawing unit repeats a drawing process for selecting the item from the group selected by the first drawing unit with a predetermined number of times set as an upper limit until the item including the character whose cumulative value is greatest is selected.

7. The game apparatus according to claim 6, wherein the second drawing unit variably sets the upper limit of a repetition count of the drawing process according to the cumulative value.

8. A non-transitory computer readable recording medium with a program stored there on, the program for, to provide a game in which an item, which includes one or more characters and in which points are set for each character, is assigned to a player, causing a computer to function as:
an item synthesizing unit adapted for, when an instruction is given to synthesize a first item and a second item out of multiple items owned by the player, updating points of a specific character common to the second item in the first item according to points of the specific character of the first item and those of the specific character of the second item.

9. A method for providing a game in which an item, which includes one or more characters and in which points are set for each character is assigned to a player, wherein:
when an instruction is given to synthesize a first item and a second item out of multiple items owned by the player, an item is generated which includes a specific character common between the first and second items and in which points of the specific character are set according to points of the specific character of the first item and those of the specific character of the second item.
